(19) United States
(12) Patent Application Publication
(10) Pub. No.: US 2004/0000126 A1
(43) Pub. Date: Jan. 1, 2004

(54) Method for diminishing delamination of a multilayer plastic container

(76) Inventors: Frank J. Schmidt, Lisle, IL (US); Armen Zakarian, Arlington Heights, IL (US); John M. Rost, Oak Forest, IL (US); Prasad Joshi, Woodridge, IL (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/188,215

(22) Filed: Jul. 1, 2002

(51) Int. Cl. B65B 7/28; B65B 55/22; B67B 3/00

(52) U.S. Cl. 53/431; 53/440; 53/471

(57) ABSTRACT

A method of filling a multilayer container includes providing a multilayer container that is subject to delamination, introducing product contents at an elevated temperature and a liquefied gas, and capping or otherwise sealing the container. The pressure within the container remains positive at temperatures at least as low as ambient, and preferably down to the lower range of household or commercial refrigeration temperatures.

### BACKGROUND

This invention relates to processing and filling containers, and more particularly to processing and/or filling multilayer plastic containers to diminish delamination.

Polyethylene terephthalate (“PET”) or other thermoplastic materials are often employed for forming containers for comestible products, including food and beverages. Bottles suitable for filling processes at which elevated temperatures are employed will be referred to herein as “hot-fillable.” Conventional hot-fillable bottles typically (but not always) employ a base design that includes a circular and continuous standing ring, a substantially frustoconical inwardly directed portion, and radially oriented ribs disposed on the inwardly directed portion. Blow molding techniques for forming multilayer bottles are well known.

Typically, hot-fillable bottles are not designed to withstand positive internal pressures, but rather such designs focus on maintaining an appropriate and desirable shape during vacuum deformation upon cooling of the contents after capping. Thus, collapsible or deformable portions are often formed in the container sidewall, and the hot-fillable base is typically designed to withstand only negative pressure. Therefore, conventional hot-fillable bases are often configured differently from bases suitable for internal pressurization, such as for carbonated soft drinks.

PET, like many suitable plastics, is permeable to oxygen. Because oxygen is detrimental to comestible products, the shelf life of comestible products in PET containers is limited or decreased by oxygen permeation through the container surfaces, and comestible products packaged in PET containers are subject to spoilage, off flavors, and oxidative degradation. In efforts to reduce oxygen permeation, an oxygen barrier or oxygen scavenging layer may be incorporated into the PET material.

The most commercially popular techniques for employing a layer of oxygen scavenging or oxygen barrier material in hot-fillable containers include forming an oxygen barrier or oxygen scavenger layer that is separated from the product by a layer of virgin PET. For example, U.S. Pat. Nos. 5,955,527; 5,639,815; 5,049,624; and/or 5,021,515 (which will be referred to as the “Packaging” patents) disclose an oxygen scavenging material that is suitable for use in multilayer bottles in hot-fill and other containers. In addition, EVOH is sometimes employed as an oxygen barrier layer in PET bottles. Typically, an exterior layer of virgin and/or regrind PET is employed as an outermost layer of the container (that is, the layer that is exposed to the ambient atmosphere).

Neither a layer of EVOH nor of the oxygen scavenging compounds disclosed in the “Packaging” patents perfectly bond with a layer of PET. EVOH, in practice, often requires a tie layer (for example, a carboxylated polypropylene, a polyvinyl acetate, or the like) between the PET and the EVOH layers to combat delamination. Some other commercially available bottles are formed in five layers without tie layers, but such bottles are prone to delamination problems. Thus, some commercially available bottles employing an oxygen barrier layer of EVOH typically employ five layers (from outside in): PET-tie layer-EVOH-tie layer-virgin PET. A five layer structure 50, which is shown in FIG. 5, includes an outermost layer 52, an innermost layer 54, an EVOH oxygen barrier layer 56, and a pair of tie layers 58. Outermost and innermost layers 52 and 54 may be any suitable material, such as PET or the like. A first one of the tie layers 58 is disposed between outermost layer 52 and the barrier layer 56, and a second one of the tie layers 58 is disposed between the innermost layer 54 and the barrier layer 56.

Although the tie layer(s) 58 (under some circumstances) enhances the adherence or mechanical strength of the structure 50 comprising layers of EVOH and PET, providing a bottle of such materials has several drawbacks. For example, injection molding a container having five layers is inherently more difficult, requiring more complex machinery and material handling, than providing a bottle of three layers. Further, the adherence between the tie layers 58 and the (PET) layers 53 and 54 and (EVOH) barrier layer 56 (or corresponding materials in other containers) may hamper recycling or reuse, as some recycling or reuse process mechanically separate multilayer containers. Thus, not only does the tie layer(s) add another material that may require to be extracted, but the enhanced bond between the PET and the tie layer(s), and the EVOH and the tie layer(s) makes mechanical separation more difficult.

Because the compounds described in “Packaging” patents adhere better to PET than does EVOH, and because such compounds are generally regarded as functionally superior to EVOH, bottles employing the compounds described and claimed in “Packaging” patents have become commercially popular while employing only three layers: PET-compound(s) disclosed in any of the “Packaging” patents-virgin PET.

U.S. Pat. No. 5,251,424, entitled “Method Of Packaging Products In Plastic Containers,” which is incorporated herein in its entirety, describes a method of hot filling a plastic container in which liquid nitrogen is introduced into the container prior to capping for providing a positive pressure therein is thereby maintained within the cooled container. The '424 patent states that advantages of such a technique include eliminating thermal effects during filling, eliminating vacuum panels, enabling reduction of container thickness, and control of the headspace. The '424 patent appears to be directed to a mono-layer bottle or a bottle that is layered with EVOH, as well as having a hemispherical bottom with an attached base cup.

### SUMMARY OF THIE INVENTION

It has been recognized that multilayer bottles are subject to delamination upon abuse or flexing of the bottle. In this regard, upon deformation of the bottle sidewall, the bonds between adjacent layers in a multilayer container may eventually become weak such that the layers may delaminate. In general, it has been found that hot-fillable bottles that employ tie layers (for example, the five layer EVOH container described above) exhibit favorable delamination characteristics compared with containers that employ various thermoplastic layers and that omit tie layers (for example, the three layer container described above). Thus, when subjected to identical abuse, deformation, and like treatment, a hot-fillable bottle employing a tie layer(s) typically is less prone to delaminate than is a hot-fillable bottle of the same geometry that does not employ a tie layer.

Vacuum-induced deformation of a hot-fillable bottle (such as, deformation of the container sidewall after a hot-filling process) after filling encourages delamination. Delamination upon manual handling or mechanical abuse may diminish the commercial appeal of hot-fillable, multilayer bottles. An individual consumer may disfavor a container having even a small delaminated portion, believing that the bottle may be defective and the sterility or freshness of the product may be compromised.

Vacuum-induced container deformation may be reduced by providing a positive pressure in the container or by diminishing the magnitude of the negative pressure therein. Further, maintaining a positive or atmospheric internal container pressure diminishes sidewall deformation in response to manual handling or mechanical abuse.

Adding a predetermined quantity of liquefied gas into the container during the hot-filling process forms a positive pressure within the container even upon cooling of the contents. Because the positive internal pressure is intended to diminish deformation of the container sidewall in response to an external force, the pressure within the container preferably is positive at ambient temperatures, at which most container abuse (such as during shipping) and related deformation is expected to occur. Zero or slight negative pressure upon cooling to common refrigeration temperatures is also contemplated.

The present invention also encompasses liquefied gas dosing of containers employed with filling processes other than hot-filling. For example, a predetermined quantity of liquefied gas may be added during an aseptic or sterile filling process, which may occur at standard or ambient temperatures. Under such conditions filling conditions, the internal positive pressure formed by the vaporized liquefied gas diminishes mechanical delamination—that is, delamination be caused by mechanical abuse as distinguished from that caused by vacuum deformation. Further, even a container filled and capped at an ambient or standard temperature would be subject to vacuum deformation upon cooling to common refrigeration temperatures, and adding liquefied gas according to the present disclosure would eliminate or diminish vacuum deformation under such conditions.

### BRIEF DESCRIPTION OF THE FIGURES

FIG. 1 is a flow chart illustrating steps according to the present invention;

FIG. 2 is a diagrammatic view of a five layer container sidewall;

FIG. 3 is a diagrammatic view of a three layer container sidewall; and

FIG. 4 is a view of a bottle that may be employed with the present method steps.

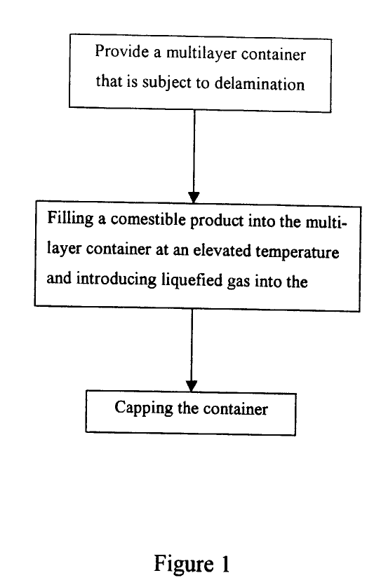

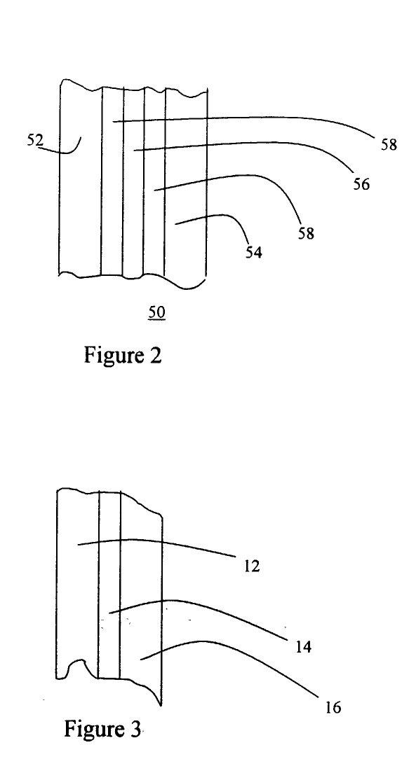

### DESCRIPTION OF A PREFERRED EMBODIMENT

According to a preferred embodiment of the present invention, a method of preventing delamination of a multilayer plastic bottle is disclosed. The present method may be employed with any bottle suitable for hot-filling that is capable of withstanding positive pressure, as explained more fully below. In this regard, a bottle 10 may be deployed. Bottle 10, as shown in FIG. 4, may be that disclosed in co-pending, concurrently filed U.S. patent application Ser. No. ______ (Attorney Docket Number 3438), which is incorporated by reference herein in its entirety. Bottle 10 is configured for maintaining positive internal pressures encountered during and subsequent to the filling process (described below), yet also capable of withstanding negative internal pressures for those circumstances in which negative internal pressures are encountered.

Alternatively, the present invention may be employed with a conventional hot-fillable container base configuration. Such a base configuration may require that its thickness be significantly larger than conventional, commercial bottles, or the base may require other processing, as will be understood and ascertained by persons familiar with such conventional base design and processing Although bottle 10 is employed to illustrate the present invention, the present invention is not limited to any particular container configuration, and may be employed with any appropriate container.

Hot-fillable multilayer bottle 10 preferably is capable of receiving liquids at conventional hot-filling process conditions (typically up to about 190 degrees F. (or higher) at 1 atmosphere for gravity filling conditions, and like temperatures with conventional higher pressure for injection filling conditions) with typical thermal deformation or shrinkage for such containers. For example, a blow molded plastic container that is subjected to conventional heat set conditions may undergo a volume reduction of approximately one percent during the hot-filling process.

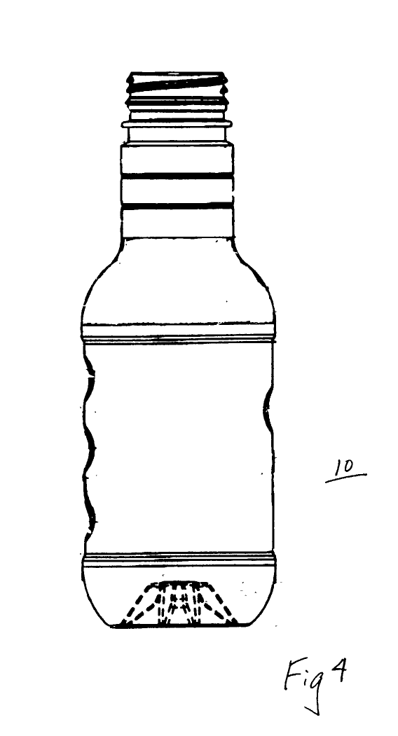

FIG. 3 illustrates a cross section of a three layer multilayer bottle, such as bottle 10, on which the method disclosed herein may be employed. The three layers include an outermost layer 12 (that is, exposed to the outer surface of the container that is in contact with the ambient atmosphere), an innermost layer 14 (that is, exposed to the inner surface of the container that is in contact with the enclosed chamber in which product contents may be disposed), and an oxygen scavenger or oxygen barrier layer 16 therebetween. The oxygen scavenger layer may be as disclosed in U.S. Pat. Nos. 5,955,527; 5,639,815; 5,049,624; and/or 5,021,515, each of which is entitled “Packaging” and assigned to the assignee of the present invention, or an oxygen barrier layer, as will be understood by persons familiar with polymer science or polymer mechanics and barrier layers in the packaging field. Each of the above “Packaging” patents is incorporated herein by reference in its entirety.

A preferred configuration of bottle 10 is such that its sidewall includes an outermost layer 12, an oxygen scavenging layer 16, and an innermost layer 14 of virgin PET that is suitable for contact with a comestible product, which encompasses any food, potable liquid, and the like. The oxygen scavenging layer preferably includes a commercially-available oxidisable organic component and a metal catalyst for the oxidation of the oxidisable organic component Preferably, the oxidisable organic component is a polymer, such as a polyamide and especially MXD6, which is a condensation polymer of m-xylylenediamine and adipic acid. The metal catalyst may include cobalt, copper, rhodium compounds and/or other suitable substances. The present invention is not limited to any particular compound for its interior (that is, generally unexposed) layer. A suitable material for the oxygen scavenging layer is OXBAR™, which is available from Crown Cork & Seal Company, Philadelphia, Pa.

Thus, a multilayer container, such as bottle 10, may be provided to a hot-fill process, during which a comestible product or the like is filled at an elevated temperature. The product may flow into the container under gravity or may be fed under pressure or employ any other filling method.

A predetermined quantity of liquefied gas, which preferably is liquefied nitrogen, is also injected into the container. The liquefied gas may be injected into the container prior to introduction of the product, during the introduction of the product, or after the introduction of the product into the container. The term “injected” as used herein with respect to the liquefied gas encompasses any technique for putting the liquefied gas into the container. Such techniques will be understood by persons familiar with nitrogen injection technology, such as that employed in injecting liquefied nitrogen into metal cans. The liquefied gas may be introduced into container 10 by any conventional method, as will be understood by persons familiar with nitrogen dosing in cans of other container packages.

After the introduction of the product and the liquefied gas and while the product is still at an elevated temperature, the container is sealed, preferably by a cap or closure. A film or liner may also be employed to seal the container. Dosing with liquefied gas enables the container to be filled to a desired level according to consumer preference. Such level control or headspace control diminishes or eliminates the problem of insufficient headspace, which often causes spilling upon initial opening of the container.

Preferably, the quantity of liquefied gas introduced into the container is such that the container internal pressure remains positive even upon cooling to sub-ambient temperatures common in household or commercial refrigeration, such as 40 to 50 degrees F. The present invention, however, is not limited to maintaining positive pressure throughout the entire temperature range that the container may encounter Rather, under certain conditions, the container internal pressure need not stay positive upon cooling to sub-ambient temperatures, such as 40 to 50 degrees, because the time period that an unopened container is expected to reside at refrigerated temperatures is expected, typically, to be small as a percentage of the total time period between capping and opening. Thus, the advantages of creating internal positive pressure in a container by nitrogen dosing may be obtained while reducing the amount of liquefied gas such that a container internal pressure is generally positive, but diminishes to approximately atmospheric pressure upon cooling to ambient conditions of approximately 72 degrees F. and one atmosphere In this regard, it has been observed that is may be acceptable to have atmospheric or negative internal pressure at refrigeration temperatures, and that liquefied gas dosing according to the present invention diminishes such negative internal pressure to provide an acceptable degree of bottle defo rmation with respect to delamination.

Because the additional positive internal container pressure prevents or diminishes delamination over much or all of the container's useful life, but does not chemically alter the adherence between the layers, a multilayer container that is dosed with liquefied gas according to the description herein is suitable for recycling upon mechanical separation. In this regard, a multilayer container that lacks tie layers or has weak tie layers may be separated by mechanical separation techniques employed during the recycling thereof. Thus, a container's commercial appeal and environmental impact may be improved over multilayer containers that are not separable.

A particular embodiment is employed to illustrate the present invention. The present invention is not limited to the particular embodiment described herein, but rather encompasses numerous variations that will be apparent to persons familiar with conventional hot-fillable container technology in view of the present disclosure. Thus, the present invention is not limited to containers that can withstand both positive and negative pressures, but rather may be employed with any container that is suitable for withstanding the positive internal pressures encountered during and after the hot-filling and nitrogen injection process. Further, the present invention is not limited to a container having any particular number of layers, or one that is processed by any particular method or conditions. Rather, the present invention may be employed with any multilayer container

We claim:

1. A method of filling a hot-fillable container that inhibits container delamination, comprising the steps of
a. providing a container formed of multiple layers and suitable for hot filling, the multiple layers excluding tie layers;
b. introducing a comestible product into the multilayer container at an elevated temperature;
c. introducing a quantity of liquefied gas into the container; and
d. capping the container so as to enable the liquefied gas to form a positive pressure inside the container before the container is cooled to ambient temperature, whereby the positive pressure inhibits delamination of the container layers.

2. The method of claim 1 wherein at least a pair of the multiple layers are mechanically separable upon recycling.

3. The method of claim 1 wherein the quantity of liquefied gas is sufficient to maintain a positive pressure within the container upon cooling to ambient temperature.

4. The method of claim 3 wherein the quantity of liquefied gas is sufficient to maintain a positive pressure within the container upon cooling to approximately 50 degrees F.

5. The method of claim 3 wherein the quantity of liquefied gas is sufficient to maintain a positive pressure within the container upon cooling to approximately 40 degrees F.

6. The method of claim 1 wherein the quantity of liquefied gas is such that the container has a substantially atmospheric pressure upon cooling to ambient temperature.

7. The method of claim 3 wherein the quantity of liquefied gas is such that the container has a negative internal pressure upon cooling to approximately 50 degrees F.

8. The method of claim 3 wherein the quantity of liquefied gas is such that the container has a negative internal pressure upon cooling to approximately 40 degrees F.

9. The method of claim 3 wherein the quantity of liquefied gas is such that the container has a substantially atmospheric internal pressure upon cooling to approximately 50 degrees F.

10. The method of claim 3 wherein the quantity of liquefied gas is such that the container has a substantially atmospheric internal pressure upon cooling to approximately 40 degrees F.

11. The method of claim 1 wherein the layers of the container include an outer layer of PET, an interior layer of an oxygen scavenging compound comprising nylon, and an inner layer of PET for contacting the product.

12. The method of claim 1 wherein the liquefied gas is an inert gas.

13. The method of claim 1 wherein the liquefied gas comprises liquefied nitrogen.

14. The method of claim 1 wherein the liquefied gas is liquefied nitrogen.

15. A method of filling a container that inhibits container delamination from internal vacuum deformation or mechanical abuse, comprising the steps of
a. providing a container formed of multiple layers, the multiple layers excluding tie layers;
b. introducing a product into the multilayer container;
c. introducing a quantity of liquefied gas into the container; and
d. capping the container so as to enable the liquefied gas to form a positive pressure inside the container, whereby the positive pressure inhibits delamination of the container layers.

16 The method of claim 15 wherein the introducing step b) and the introducing step c) are performed at approximately room temperature.

17. The method of claim 16 wherein the product is a comestible product.

18. The method of claim 16 wherein the product is water.

19. The method of claim 15 wherein the introducing step b) and the introducing step c) are performed at an elevated temperature.

20. The method of claim 15 wherein at least a pair of the multiple layers are mechanically separable upon recycling.

21. The method of claim 15 wherein the quantity of liquefied gas is sufficient to maintain a positive pressure within the container upon cooling to approximately 50 degrees F.

22. The method of claim 15 wherein the quantity of liquefied gas is sufficient to maintain a positive pressure within the container upon cooling to approximately 40 degrees F.

23. The method of claim 15 wherein the quantity of liquefied gas is such that the container has a negative internal pressure upon cooling to approximately 50 degrees F.

24. The method of claim 15 wherein the quantity of liquefied gas is such that the container has a negative internal pressure upon cooling to approximately 40 degrees F.

25 The method of claim 15 wherein the quantity of liquefied gas is such that the container has a substantially atmospheric internal pressure upon cooling to approximately 50 degrees F.

26. The method of claim 15 wherein the quantity of liquefied gas is such that the container has a substantially atmospheric internal pressure upon cooling to approximately 40 degrees F.

27. The method of claim 15 wherein the layers of the container include an outer layer of PET, an interior layer of an oxygen scavenging compound comprising nylon, and an inner layer of PET for contacting the product.

28. The method of claim 15 wherein the liquefied gas is an inert gas.

29. The method of claim 15 wherein the liquefied gas comprises liquefied nitrogen.

30. The method of claim 15 wherein the liquefied gas is liquefied nitrogen.
